(19) United States
(12) Patent Application Publication
(10) Pub. No.: US 2014/0156088 A1
(43) Pub. Date: Jun. 5, 2014

(54) ENERGY MANAGEMENT SYSTEMS AND METHODS

(71) Applicant: EZ GREEN INC., Foster City, CA (US)

(72) Inventors: Jiechao Li, Foster City, CA (US); Gayathri Raghavendra, Foster City, CA (US)

(73) Assignee: EZ Green Inc., Foster City, CA (US)

(21) Appl. No.: 13/706,228

(22) Filed: Dec. 5, 2012

(51) Int. Cl. G05B 13/02

(52) U.S. Cl. CPC G05B 13/02
USPC 700/278

(57) ABSTRACT

Provided are energy management systems which are configured to receive real-time outside temperature at the location of a building, receive initial temperature control set points for each of one or more zones inside the building and adjust the temperature control set points for each zone of the plurality, taking the outside temperature and the initial temperature control set points for the zone as parameters. The adjusted set points can then be used to guide heating and/or cooling in the respective zone. Methods of setting up and using the systems are also provided.

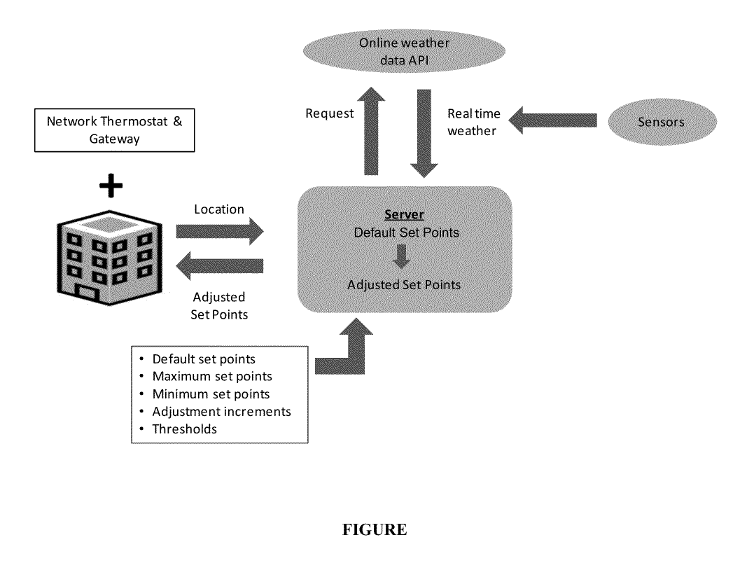

### FIELD OF THE DISCLOSURE

The present invention generally relates to the systems and methods for the management of energy use in a building. Such systems can include heating, ventilation and/or cooling equipments and related control devices and processes.

### BACKGROUND

Currently available building energy management systems that use set based control of Heating, Ventilation and Air Conditioning (HVAC) systems typically use two methods to determine and adjust the set points in order to guide energy use and conservation: (a) pre-determined occupancy schedules i.e. preset information on when occupants are in a building; and/or (b) occupancy data from occupancy sensors.

The following is an example in which pre-determined occupancy schedule is used to determine set points for HVAC control.

### Occupied [Monday-Friday 9 AM to 7 PM]

Heating set point: 68° F.

Cooling set point: 72° F.

### Un-occupied [Monday-Friday 7.01 PM to 8.59 AM; Saturday-Sunday]

Heating set point: 50° F.

Cooling set point: 85° F.

Many building spaces, in particular those in a commercial facility, however, have transient occupancy. Examples of such commercial facilities include retail stores, where customers step in for a short time to make a purchase; a restaurant where customers dine in the building for a hour or two; an un-manned office lobby, through which employees or visitors walk to reach the office areas.

Such transient occupancy, therefore, poses challenges to HVAC control and a suboptimal HVAC control leads to energy waste or lack of comfort for the occupants. For instance, if there is a large differential between the outside weather condition and the indoor temperature, the comfort of the occupants is compromised due to a drastic temperature change within a short period of time when an occupant moves in or out of the building. By the same token, energy is wasted for creating such a useless temperature differential.

### SUMMARY

One embodiment of the present disclosure provides a system comprising memory, a processor and program code which, when executed by the processor, configures the system to receive real-time outside temperature at the location of a building; receive initial temperature control set points for each of one or more zones inside the building; and adjust the temperature control set points for each zone of the plurality, taking the outside temperature and the initial temperature control set points for the zone as parameters. In one embodiment, the system is further configured to send the adjusted temperature control set points to each of the zones to guide heating and/or cooling in the zone.

In some aspects, the real-time outside temperature is determined at the location. In some aspects, the real-time outside temperature is determined with a temperature sensor at the location. In some aspects, the real-time outside temperature is retrieved from a weather database. In some aspects, the system is further configured to receive the location of the building, which can be used to retrieve weather information for the building.

In some aspects, the system is further configured to determine the initial temperature control set points based on an occupancy schedule in the zone. In one aspect, the system is further configured to determine the occupancy schedule. In one aspect, the occupancy schedule is determined with an occupancy sensor. In addition or alternatively, in one aspect, the occupancy schedule is determined with input from a user. In some aspects, the system is further configured to determine the inside temperature in each of the plurality of zones.

In some aspects, the initial temperature control set points comprise a default heating set point (DefHSP), which indicates a need of heating when the inside temperature in a zone is below the DefHSP. In one aspect, the initial temperature control set points further comprise a minimum heating set point (MinHSP), which indicates that heating is required, regardless of the outside temperature, when the insider temperature in a zone is below the MinHSP.

In some aspects, the adjustment further takes as parameters one or more reference points. Non-limiting examples of reference points include a heating upper threshold (HUT) and a heating lower threshold (HLT). In some aspects, the reference points further comprise one or more heating intermediate thresholds (HIT₁, HIT₂ . . . HITₙ₋₁ and HITₙ) and one or more heating adjustment increments (H-INCR₁, H-INCR₂ . . . H-INCRₙ₋₁ and H-INCRₙ).

In some aspects, the DefHSP is adjusted to an adjusted heating set point (AdjHSP) that is:

DefHSP, if the outside temperature is higher than HUT;

DefHSP−H-INCR₁, if the outside temperature is between HUT and HIT₁;

DefHSP−H-INCR₂, if the outside temperature is between HIT₁ and HIT₂;

DefHSP−H-INCR₂, if the outside temperature is between HITₙ₋₁ and HITₙ; or

MinHSP, if the outside temperature is lower than HLT.

In some aspects, the initial temperature control set points comprise a default cooling set point (DefCSP), which indicates a need of cooling when the inside temperature in a zone is above the DefCSP. In some aspects, the initial temperature control set points further comprise a maximum cooling set point (MaxCSP), which indicates that cooling is required, regardless of the outside temperature, when the insider temperature in a zone is above the MaxCSP.

In some aspects, the adjustment further takes as parameters one or more reference points. Non-limiting examples include cooling lower threshold (CLT) and a cooling upper threshold (CUT). In some aspects, the reference points further comprise one or more cooling intermediate thresholds (CIT₁, CIT₂ . . . CITₙ₋₁ and CITₙ) and one or more cooling adjustment increments (C-INCR₁, C-INCR₂ . . . C-INCRₙ₋₁ and C-INCRₙ).

In some aspects, the DefCSP is adjusted to an adjusted heating set point (AdjCSP) that is:

DefCSP, if the outside temperature is lower than CLT;

DefCSP+C-INCR₁, if the outside temperature is between CLT and CIT₁;

DefCSP+C-INCR₂, if the outside temperature is between CIT₁ and CIT₂;

DefCSP−C-INCRₙ, if the outside temperature is between CITₙ₋₁ and CITₙ; or MaxCSP, if the outside temperature is higher than CUT.

In some aspects, the receiving and/or sending comprises wireless data transmission, or alternatively, through wired data transmission.

Methods and computer-readable media are also provided. In one embodiment, provided is a method for guiding heating and/or cooling in a building, comprising, receiving real-time outside temperature at the location of a building; receiving initial temperature control set points for each of one or more zones inside the building; and adjusting the temperature control set points for each zone of the plurality, taking the outside temperature and the initial temperature control set points for the zone as parameters, wherein at least one of the steps is performed by a computer.

In another embodiment, provided is a non-transitory computer-readable medium comprising program code which, when executed, configures a system to receive real-time outside temperature at the location of a building; receive initial temperature control set points for each of one or more zones inside the building; and adjust the temperature control set points for each zone of the plurality, taking the outside temperature and the initial temperature control set points for the zone as parameters.

### BRIEF DESCRIPTION OF THE DRAWINGS

Provided embodiments are illustrated by way of example, and not limitation, in the FIGURE of the accompanying drawing which illustrates an exemplary energy management system.

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION

As used herein, certain terms have the following defined meanings. Terms that are not defined have their art recognized meanings.

As used in the specification and claims, the singular form “a”, “an” and “the” include plural references unless the context clearly dictates otherwise.

As used herein, the term “comprising” is intended to mean that the components, systems and methods include the recited elements, but not excluding others. “Consisting essentially of” when used to define components, systems and methods, shall mean excluding other elements that would materially affect the basic and novel characteristics of the disclosure. “Consisting of” shall mean excluding any element, step, or component not specified in the claim. Embodiments defined by each of these transition terms are within the scope of this disclosure.

### DETAILS OF THE DISCLOSURE

The present disclosure provides methods and related systems to optimize the energy management in a building. The methods take into consideration weather information pertaining to the location of the building to minimize energy use and maximize occupant comfort. For instance, when the real-time outside temperature is high, the default cooling set point (i.e., a temperature threshold above which the cooling system may be activated) can be increased to reduce cooling. That way, a person that walks into the building from the outside would not experience discomfort due to the sudden temperature change, or conversely, a person that walks out of the building would not suffer such discomfort either. Further, due to the reduced cooling burden, in particular during a hot day and when the occupancy in the building is relatively low, energy saving can be significant.

In accordance with one embodiment of the disclosure, therefore, provided is a method for adjusting heating and/or cooling set points for temperature control in a building, such adjusting taking real-time outside temperature at the location of the building as a parameter. In some aspects, the cooling set points are increased when the outside temperature goes up, and vice versa. In some aspects, the heating set points are decreased when the outside temperature goes down, and vice versa.

The objective of one embodiment of the present disclosure is to determine and/or adjust the heating and/or cooling set points dynamically. Such determination can take one or more of many factors, in addition to the outside temperature, into consideration. Non-limiting examples of such factors include occupancy schedule and occupant preference, location, historic weather data, energy conservation targets or goals, and age or condition of the heating and cooling equipments.

### Heating and Cooling Set Points

In accordance with one embodiment of the present disclosure, one or more temperature control set points are contemplated. In one aspect, the temperature control set points include one or more heating set points. In another aspect, the temperature control set points include one or more cooling set points.

One of the one or more heating set points, in some aspects, is a default heating set point (DefHSP), which is commonly used in conventional thermostats. For instance, when the DefHSP is set at 65 degrees Fahrenheit, heating will be started if the inside temperature in a building, or in a zone of the building, is below 65 degrees.

Also provided, in some aspects, is a minimum heating set point (MinHSP), such as 60 degrees Fahrenheit. The MinHSP refers to a minimum temperature that the building or a zone in the building must maintain at a specific time point. Such a MinHSP may be required to ensure comfort or safety of the occupants in the building or the building itself.

Likewise, in one embodiment, the temperature control set points include a default cooling set point (DefCSP), such as 72 degrees Fahrenheit. When the inside temperature is above the DefCSP, air conditioning can be triggered. In another embodiment, the temperature control set points further include a maximum cooling set point (MaxCSP), such as 75 degrees. The MaxCSP refers to a maximum temperature that the building or a zone in the building cannot exceed at a specific time point. Like the MinHSP, the MaxCSP is used to ensure comfort or safety of the occupants in the building or the building itself.

It is to be understood that the temperature control set points, including heating set points and cooling set points, can be specific to the building, zone, occupants, date and time and can be adjusted. For instance, the DefHSP and MinHSP can be lower at night or when occupancy is low. Other factors, as described above, can also be considered in determining these set points, which methods are also within the scope of the present disclosure.

In one aspect, the heating and/or cooling set points are entered by a user, which can take the form of an occupancy schedule. For instance, the user can set a 65 (DefHSP)-72 (DefCSP) set point range for the day when the occupancy is high and 62 (DefHSP)-74 (DefCSP) for night and weekends when the occupancy is low. Likewise, the user can further set a 60 (MinHSP)-75 (MaxCSP) set point range for the day and 55 (MinHSP)-80 (MaxCSP) for the night.

In another aspect, the heating and/or cooling set points are determined by the real-time occupancy or an occupancy schedule. In one aspect, the occupancy is determined by a sensor, such as an occupancy sensor. Occupancy sensors are known in the art. For instance, an occupancy sensor can be a motion sensor to detect the presence of occupants in a building, or alternatively by counting entering and exiting of persons through an entrance.

### Real-Time Outside Temperature

One embodiment of the present disclosure provides methods and systems to adjust temperature control set points for a building or a zone in a building taking into consideration temperature outside the building. In one aspect, the outside temperature is determined at the location of the building.

In one aspect, the outside temperature is determined with a temperature sensor, such as a thermometer, located at the location. In another aspect, the outside temperature can be retrieved electronically, from a weather database that includes temperature for the location, or the general area.

To this end, in one aspect, the location of the building is received or determined which is then used to query the weather database. Location of the building can be determined with a location sensor, such as one used in a global positioning system (GPS). Alternatively, the location can be determined wirelessly, such as using a Wifi or wireless location database. Still in another aspect, the location can be entered by a user.

Not only the outside temperature can be used to adjust the temperature control set points in a building or a zone in a building, other weather information can also be considered. For instance, in one aspect, the brightness and/or speed of wind outside of the building can also contribute to temperature control and occupant comfort and they can be used as parameters for adjusting the set points as well.

### Adjustment of Set Points

In accordance with one embodiment of the disclosure, the temperature control set points (e.g., DefHSP, DefHSP, MinHSP and MaxCSP) for a building or one or more zones in a building are adjusted taking into consideration the outside temperature. In some aspects, the adjustment entails the use of one or more set points which can be entered by a user or determined by the system.

For the heating set points adjustment, for instance, the methods and systems of the present disclosure generate and/or take advantages one or more reference points. Two such reference points include a heating upper threshold (HUT) and a heating lower threshold (HLT). In one embodiment, the reference points further include one or more heating intermediate thresholds (HIT₁, HIT₂ . . . HITₙ₋₁ and HITₙ) and one or more heating adjustment increments (H-INCR₁, H-INCR₂ . . . H-INCRₙ₋₁ and H-INCRₙ).

For the purpose of illustration only, the following table provides an example of values for these set points and reference points, for a zone in a building at a particular time point during a particular day.

| Set/reference point | Temperature (° F.) |
|---|---|
| DefHSP | 65 |
| MinHSP | 60 |
| HUT | 50 |
| HIT₁ | 48 |
| HIT₂ | 46 |
| HITₙ₋₁ | 38 |
| HITₙ | 36 |
| HLT | 34 |
| H-INCR₁ | 0.5 |
| H-INCR₂ | 1 |
| H-INCRₙ₋₁ | 4 |
| H-INCRₙ | 4.5 |

As provided above, DefHSP denotes a default heating set point. When the inside temperature is below this temperature, heating is desired. MinHSP denotes a minimum temperature, for the purpose of further reducing the use of heating (i.e., decrease the DefHSP), but not exceed a minimum value. In one embodiment of the present disclosure, the DefHSP is adjusted to an adjust default heating set point (AdjHSP) which is between the DefHSP and MinHSP. The amount of adjustment, in one aspect, depends on the value of the outside temperature, relative to HUT, HLT and a number of HIT (HIT₁, HIT₂ . . . HITₙ₋₁ and HITₙ) between them.

In one embodiment, the adjustment is performed according to the following rules:

### AdjDSP=

DefHSP, if the outside temperature is higher than HUT;

DefHSP−H-INCR₁, if the outside temperature is between HUT and HIT₁;

DefHSP−H-INCR₂, if the outside temperature is between HIT₁ and HIT₂;

DefHSP−H-INCRₙ, if the outside temperature is between HITₙ₋₁ and HITₙ; or

MinHSP, if the outside temperature is lower than HLT.

Still using the values in the table above as an example, when the outside temperature is above the HUT (50° F.), adjustment of the DefHSP is not needed, and thus it remains at 65° F. When the outside temperature goes further down, to between HUT and HIT1, at e.g., 49° F., the adjustment algorithm is triggered and the AdjHSP is set at DefHSP (65° F.)−H-INCR₁ (0.5° F.)=64.5° F.

If the outside temperature is further lower, at for instance, 37° F. which is between HITₙ₋₁ and HITₙ, then the AdjHSP becomes DefHSP (65° F.)−H-INCRₙ (4.5° F.)=60.5° F. Once the outside temperature is lower than HLT (34° F.), then no matter how low it becomes, however, the AdjHSP stays at MinHSP (60° F.) and cannot be further reduced.

The adjustment of the cooling set points, in one aspect, mirrors the adjustment of the heating set points. For instance, the adjustment takes in consideration certain reference points that can include a cooling upper threshold (CUT) and a cooling lower threshold (CLT). In one embodiment, the reference points further include one or more cooling intermediate thresholds (CIT₁, CIT₂ . . . CITₙ₋₁ and CITₙ) and one or more heating adjustment increments (C-INCR₁, C-INCR₂ . . . C-INCRₙ₋₁ and C-INCRₙ). The following table provides an illustrative example of values for certain cooling set points and reference points for the use of the adjustment.

| Set/refernece point | Temperature (° F.) |
|---|---|
| DefCSP | 72 |
| MaxCSP | 78 |
| CLT | 80 |
| CIT₁ | 82 |
| CIT₂ | 84 |
| CITₙ₋₁ | 88 |
| CITₙ | 90 |
| CUT | 92 |
| C-INCR₁ | 0.5 |
| C-INCR₂ | 1 |
| C-INCRₙ₋₁ | 5 |
| C-INCRₙ | 5.5 |

In one embodiment, the adjustment is performed according to the following rules:

The adjusted default cooling set point (AdjCSP)=

DefCSP, if the outside temperature is lower than CLT;

DefCSP+C-INCR₁, if the outside temperature is between CLT and CIT₁;

DefCSP+C-INCR₂, if the outside temperature is between CIT₁ and CIT₂;

DefCSP−C-INCRₙ, if the outside temperature is between CITₙ₋₁ and CITₙ; or

MaxCSP, if the outside temperature is higher than CUT.

The following table provides an example of values of AdjCSP, according to the outside temperature.

| Outside temperature (° F.) | AdjCSP (° F.) |
|---|---|
| 78 | 72 |
| 81 | 72.5 |
| 88 | 77 |
| 95 | 78 |

It is contemplated that any or all of the temperature control set points can be entered by a user, depending on the user preference or desired comfort. Also provided, further, are methods to determine some or all the set points and/or reference points. For instance, once a user sets a DefHSP at 68° F., the system of the present disclosure can automatically set the MinHSP at 5° F. lower, to 63° F. In such a case, the HUT, HLT and HIT's can remain the same or increase or decrease accordingly.

Adjustment of any of the set points and/or reference points can take into consideration of factors such as occupancy schedule and occupant preference, location, historic weather data, energy conservation targets or goals, and age or condition of the heating and cooling equipments.

In terms of occupant preference, in addition to directly setting the set points, an occupant can opt to choose from a list of comfort and/or energy conservation options. Without limitation, a maximum energy conservation option can have a lower MinHSP than a less aggressive energy conservation option.

In one embodiment, the methods or systems of the present disclosure further envision taking record of settings and adjustment of the set points, and the resulting temperature change in a zone. Optionally, the energy use associated with such adjustment is also recorded. As such, the system can be used to measure the efficiency of the heating/cooling system and/or the benefit of such adjustment.

Once the default temperature set points (DefHSP and DefCSP) are adjusted according to the outside temperature, in one aspect, the adjusted values are sent back to the zone to guide heating and/or cooling in the zone. Methods of using temperature set points to control heating and/or cooling in a zone are known in the art, e.g., by using a thermostat, which measures the inside temperature and initiates or stops heating/cooling accordingly.

In some aspects, the communication between the central system that performs the adjustment, and the various sensors or databases is through internet. The internet connection can be wireless or wired, without limitation.

The attached FIGURE illustrates such a system. The system can include a server, which can be a conventional computer or a cloud-based system. The server communicates with the heating/cooling equipments in a building, retrieves the building's location and initial set of temperature control set points. Through an online weather database's application program interface (API), the server can retrieve outside temperature and other weather information for the location of the building. Alternatively, the real-time outside temperature can be determined by a sensor.

Within the server, which can be centralized or distributed, the initial set of temperature set points are examined in light of the real-time outside temperature of the building. If necessary, e.g., when the outside temperature is below HUT or above CLT, such set points can be adjusted. The adjusted set points are then sent back to the building to guide heating and/or cooling in the building.

Alternatively, not illustrated in the FIGURE, the system that carries out the adjustment of temperature control set points can be assembled within a building, such as inside a thermostat, without limitation.

### Computer Network

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually. In case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A system comprising memory, a processor and program code which, when executed by the processor, configures the system to:
receive real-time outside temperature at the location of a building;
receive initial temperature control set points for each of one or more zones inside the building; and
adjust the temperature control set points for each zone of the plurality, taking the outside temperature and the initial temperature control set points for the zone as parameters.

2. The system of claim 1, wherein the system is further configured to send the adjusted temperature control set points to each of the zones to guide heating and/or cooling in the zone.

3. The system of claim 1, wherein the system is further configured to receive the location of the building.

4. The system of claim 1, wherein the real-time outside temperature is determined at the location.

5. The system of claim 4, wherein the real-time outside temperature is determined with a temperature sensor at the location.

6. The system of claim 1, wherein the real-time outside temperature is retrieved from a weather database.

7. The system of claim 1, wherein the system is further configured to determine the initial temperature control set points based on an occupancy schedule in the zone.

8. The system of claim 7, wherein the system is further configured to determine the occupancy schedule.

9. The system of claim 8, wherein the occupancy schedule is determined with an occupancy sensor.

10. The system of claim 8, wherein the occupancy schedule is determined with input from a user.

11. The system of claim 1, wherein the system is further configured to determine the inside temperature in each of the plurality of zones.

12. The system of claim 1, wherein the initial temperature control set points comprise a default heating set point (DefHSP), which indicates a need of heating when the inside temperature in a zone is below the DefHSP.

13. The system of claim 12, wherein the initial temperature control set points further comprise a minimum heating set point (MinHSP), which indicates that heating is required, regardless of the outside temperature, when the insider temperature in a zone is below the MinHSP.

14. The system of claim 13, wherein the adjustment further take a heating upper threshold (HUT) and a heating lower threshold (HLT) as parameters.

15. The system of claim 14, wherein the adjustment further takes one or more heating intermediate thresholds (HIT₁, HIT₂ . . . HITₙ₋₁ and HITₙ) and one or more heating adjustment increments (H-INCR₁, H-INCR₂ . . . H-INCRₙ₋₁ and H-INCRₙ) as parameters.

16. The system of claim 15, wherein the DefHSP is adjusted to an adjusted heating set point (AdjHSP) that is:
DefHSP, if the outside temperature is higher than HUT;
DefHSP−H-INCR₁, if the outside temperature is between HUT and HIT₁;
DefHSP−H-INCR₂, if the outside temperature is between HIT₁ and HIT₂;
DefHSP−H-INCRₙ, if the outside temperature is between HITₙ₋₁ and HITₙ; or
MinHSP, if the outside temperature is lower than HLT.

17. The system of claim 1, wherein the initial temperature control set points comprise a default cooling set point (DefCSP), which indicates a need of cooling when the inside temperature in a zone is above the DefCSP.

18. The system of claim 17, wherein the initial temperature control set points further comprise a maximum cooling set point (MaxCSP), which indicates that cooling is required, regardless of the outside temperature, when the insider temperature in a zone is above the MaxCSP.

19. The system of claim 18, wherein the adjustment further takes cooling lower threshold (CLT) and a cooling upper threshold (CUT) as parameters.

20. The system of claim 19, wherein the adjustment further takes one or more cooling intermediate thresholds (CIT₁, CIT₂ . . . CITₙ₋₁ and CITₙ) and one or more cooling adjustment increments (C-INCR₁, C-INCR₂ . . . C-INCRₙ₋₁ and C-INCRₙ) as parameters.

21. The system of claim 20, wherein the DefCSP is adjusted to an adjusted heating set point (AdjCSP) that is:
DefCSP, if the outside temperature is lower than CLT;
DefCSP+C-INCR₁, if the outside temperature is between CLT and CIT₁;
DefCSP+C-INCR₂, if the outside temperature is between CIT₁ and CIT₂;
DefCSP−C-INCRₙ, if the outside temperature is between CITₙ₋₁ and CITₙ; or
MaxCSP, if the outside temperature is higher than CUT.

22. The system of claim 1, wherein the receiving and/or sending comprises wireless data transmission.

23. The system of claim 1, wherein the receiving and/or sending is through wired data transmission.

24. A method for guiding heating and/or cooling in a building, comprising:
receiving real-time outside temperature at the location of a building;
receiving initial temperature control set points for each of one or more zones inside the building; and
adjusting the temperature control set points for each zone of the plurality, taking the outside temperature and the initial temperature control set points for the zone as parameters, wherein at least one of the steps is performed by a computer.

25. A non-transitory computer-readable medium comprising program code which, when executed, configures a system to:
receive real-time outside temperature at the location of a building;
receive initial temperature control set points for each of one or more zones inside the building; and
adjust the temperature control set points for each zone of the plurality, taking the outside temperature and the initial temperature control set points for the zone as parameters.
